(19) United States
(12) Patent Application Publication
(10) Pub. No.: US 2023/0093927 A1
(43) Pub. Date: Mar. 30, 2023

(54) MODULAR DEVICE TO ALERT DRIVERS AND VEHICLE OCCUPANTS TO PREVENT LOSS OF VALUABLE AND INJURY IN HOT VEHICLES

(71) Applicants: Harkewal Singh, Ashland, MA (US); Richa Dhatwalia Bandesha, Ashland, MA (US)

(72) Inventors: Harkewal Singh, Ashland, MA (US); Richa Dhatwalia Bandesha, Ashland, MA (US)

(21) Appl. No.: 17/697,131

(22) Filed: Mar. 17, 2022

Related U.S. Application Data
(60) Provisional application No. 63/248,428, filed on Sep. 25, 2021.

(51) Int. Cl. B60Q 9/00; G06F 3/16; B60J 5/04; G01L 1/22

(52) U.S. Cl. CPC B60Q 9/00; G06F 3/16; B60J 5/0468; G01L 1/22

(57) ABSTRACT

A vehicle safety device for reminding a vehicle operator or occupant of a valuable or person in the car is disclosed. The vehicle safety device includes at least one sensor attached to a door latch of a vehicle. A sound module is in communication with the at least one sensor to emit an audible customizable recording, wherein the audible customizable recording is emitted once the door is opened. A smart device is in communication with the sound module, the smart device to permit a user to record the audible customizable recording. The vehicle safety device aids in the prevention of lost or damaged property and injury to individuals due to heatstroke.

### CROSS-REFERENCE TO RELATED APPLICATIONS

The present application claims priority to U.S. Provisional Patent Application No. 63/248,428 filed Sep. 24, 2021, entitled “A MODULAR DEVICE TO ALERT DRIVERS/VEHICLE OCCUPANTS AND PREVENT LOSS OF VALUABLES AND POSSIBLY DEATH IN HOT CARS” which is hereby incorporated by reference in its entirety.

### TECHNICAL FIELD

Embodiments relate generally to vehicle safety systems and more specifically to a device to alert and remind vehicle drivers and/or occupants to prevent loss of valuable items and prevent injury and/or death from heatstroke.

### BACKGROUND

Between 1990 and 2018, there have been at least 891 child fatalities by vehicular heatstroke with 56% of these cases happening unknowingly by an otherwise responsible parent or caregiver. These accidents not only cause loss of life or valuables but leave behind a trail of everlasting sorrow and unhappiness.

The current arts include various devices to prevent vehicular heatstroke. For example, one technology involves the usage of infrared sensors positioned in the vehicle that automatically detect the present of a child and alerts the driver in the case the driver exits the vehicle. Another known technology is the presence of a weight sensor on car seats to detect if the child is still present and inform the driver or vehicle occupant via their smart device. Although helpful, these technologies and resulting devices are expensive and depend on the reliable connectivity to a smart device. Furthermore, these solutions are limited to only prevent tragedies caused by excessive heat inside the vehicle (e.g., such as when the vehicle is parked in direct sunlight).

In another example, some vehicle manufacturers have incorporated radar inside the roof of the vehicle, above the rear seat which can detect passenger (e.g., children) movements in as quickly as 10 seconds. These technologies, however, are only for families who own these specific vehicles and are not configurable to be installed in other vehicles.

Recent legislation “Hot Cars Act of 2021” requires new motor vehicles to have an alert system that reminds vehicle operators and/or occupants to not leave their children or pets in the vehicle. However, the new legislation only focuses on new vehicles and does not provide motivation for vehicle owners to outfit their existing vehicles with the safety systems such as those described above.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

Embodiments described herein relate to a vehicle safety device for reminding a vehicle operator or occupant of a valuable or person in the car. The vehicle safety device includes at least one sensor attached to a door latch of a vehicle. A sound module is in communication with at least one sensor to emit an audible customizable recording, wherein the audible customizable recording is emitted once the door is opened. A smart device is in communication with the sound module, to permit a user to record the audible customizable recording. The vehicle safety device aids in the prevention of lost or damaged property and injury to individuals due to heatstroke.

The embodiments are intended to remind people to look in their daily use vehicles or emergency vehicles as they are exiting to ensure sensitive items and/or persons are not left within the vehicle upon exiting. By virtue of this device's places ent in the vehicle, it presents a fail-safe mechanism which overrides human error and forgetfulness. The device is intended to be simplistic in design and nature rendering the device easy to install and utilize.

In one aspect, at least one sensor is a force-resistive touch sensor or pressure sensor is provided.

In one aspect, the at least one sensor includes an adhesive to attach the at least one sensor to the door.

In one aspect, the at least one sensor is attached to a door handle/latch.

In one aspect, a first power source is in electrical communication with at least one sensor and a second power source in electrical communication with the sound module. In another aspect, a single power source is utilized.

In one aspect, the first power source and the second power source is a Li Poly battery. One skilled in the arts will readily understand that various power sources may be utilized.

In one aspect, a transmitter is in communication with the at least one sensor, the transmitter to emit an output signal once the door is opened.

In one aspect, a receiver is in communication with the sound module, the receiver to receive the output signal from the transmitter.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a schematic of the device interfaced with the door of a vehicle, according to some embodiments;

FIG. 2 illustrates a block diagram of the device components, according to some embodiments;

FIG. 3 illustrates a schematic of the interior of the door panel, according to some embodiments; and

FIG. 4 illustrates a perspective view of the interior of the vehicle, according to some embodiments.

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments are intended to remind people to look in their daily use vehicles or emergency vehicles as they are exiting to ensure sensitive items and/or persons are not left within the vehicle upon exiting. By virtue of this device's placement in the vehicle, it presents a fail-safe mechanism which overrides human error and forgetfulness. The device is intended to be simplistic in design and nature, rendering the device easy to install and utilize.

The device is a fail-safe mechanism which can be mounted at the inside panel of the vehicle door. To exit the vehicle, the vehicle operator or passenger unlatches the door using his fingers or hands. In doing so, the device will remind the vehicle operator and/or passenger to pay attention to their belongings as well as persons or pets inside the vehicle.

The embodiments are intended to provide a customizable verbal reminder to the driver and/or occupants of a vehicle to inspect the interior of the vehicle for persons and valuable items. The customized verbal reminder may also be utilized to remind the vehicle operator and/or occupants to gather and/or hide valuable items before exiting the vehicle. The device may be used by civilians, law enforcement, military personnel, emergency personnel, etc.

Persons inside the vehicle may include children, elderly, pets, parents, co-passengers, and the like. This may also include items including valuables as well as items which may be sensitive to heat or cold.

The device may be applied universally to any vehicle regardless of its make, year, capacity, or vehicle type (i.e., car, truck, sport utility vehicle (SUV), emergency vehicle, etc.). Furthermore, the device may be applied to doors in a home, office, and/or business.

The embodiments include a device attached on the inside latch on the door panel of the vehicle door which connects to a force-sensitive resistor strip on the door handle to a sound module box with a speaker. Anytime the driver exits the vehicle, he will use his fingers to open the door via the handle/latch. As the handle detects a physical touch or pressure, a pre-recorded message will be played from the sound box to “check the rear car seat before exiting the vehicle”. This may be readily changed by the user to re-record a new customizable message. This creates a fail-safe mechanism as every individual exits the vehicle in the same manner by using their hand and/or fingers to operate the door handle or button as available in some new electric or combustible vehicles (e.g., Tesla). The device may be connected to a near-frequency communication capable device (e.g., a smart device) to play the pre-recorded message on the smart device in addition to within the vehicle itself.

In some embodiments, the device may be utilized to assist in any function which requires reminders or where human memory lapse can cause significant consequences (e.g., property loss, loss of life, property damage, etc.).

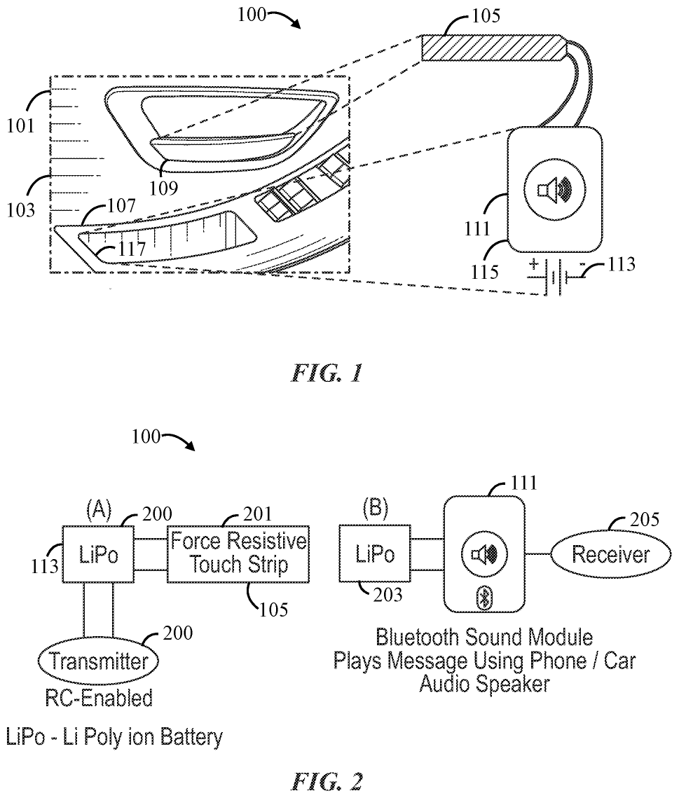

FIG. 1 illustrates a schematic of the device 100 interfaced with the door 101 of a vehicle 103. The device includes at least one sensor 105 positioned on the door 101 of the vehicle. In some embodiments, the at least one sensor 105 is positioned on the inner side 107 of the door handle 109, such that the at least one sensor 105 may sense the force of the user's hand and/or fingers engaging and operating the door handle 109. The at least one sensor 105 is in communication with a sound module 111 with a power source 113 (e.g., a battery, rechargeable battery, etc.) and adhesive 115 to attach the sound module 111 to a surface 117 of the door 101.

FIG. 2 illustrates a block diagram of the device 100 components including a transmitter 200 to permit remote control capabilities. The at least one sensor 105 may be provided as a force-resistive strip 201 in electrical communication with a power source 113 which may be a Li Poly battery or other power source capable of supplying power to the device 100. A second power source 203 may be in communication with a sound module 111 capable of emitting an audio signal which includes the customizable pre-recorded message. The transmitter 200 emits a signal to a receiver 205 when the at least one sensor 105 is touched. The receiver 205 then emits an output signal to the sound module 111 to play the customizable recording.

In some embodiments, the transmitter 200 may be in wired or wireless communication with the receiver 205. For example, wireless communication may be accomplished via NFC protocols (e.g., Bluetooth).

In some embodiments, the device 100 is in communication with a smart device 207 operating an application program to permit the user to interact with a user interface and user interface module. The user interface is in communication with an application program to allow the user (e.g., the vehicle operator and/or vehicle occupants) to interact with the device 100 such as to turn the device ON or OFF, program the device, and record a customizable recording. In such, the user may record the customizable recording using their smart device. The customizable recording is stored in a database such that the user may select from various recordings stored in the database.

In some embodiments, the application instructions for carrying out operations of the present disclosure can be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages. The application instructions can execute entirely on the user's virtual or physical computer, partly on the user's computer, as a stand-alone software package, partly on the user's computer and partly on a remote computer, or partly on a virtual computer, or entirely on the remote computer or server or any combination thereof. In the latter scenario, the remote computer can be connected to the user's computer through any type of network, including a local area network (LAN) or a wide area network (WAN), a virtual private network (VPN), an enterprise private network (EPN), or the connection can be made to an external computer (for example, through the Internet using an Internet Service Provider or a Representational State Transfer API Endpoint (RESTful API endpoint)). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform aspects of the present disclosure.

In some embodiments, the application instructions can be downloaded to a computing/processing device from a computer-readable storage medium, or to an external computer or external storage device via any type of network. A network adapter card or network interface in each computing/processing device receives computer readable program instructions from the network and forwards the computer readable application instructions for storage in a computer-readable storage medium within the respective computing/processing device.

In some embodiments, the computer system includes one or more interfaces that allow the computer system to interact with other systems, devices, or computing environments. In some embodiments, the computer system comprises a network interface to communicate with a network. In some embodiments, the network interface is configured to allow data to be exchanged between the computer system and other devices attached to the network, such as other computer systems, or between nodes of the computer system. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface and the peripheral device interface.

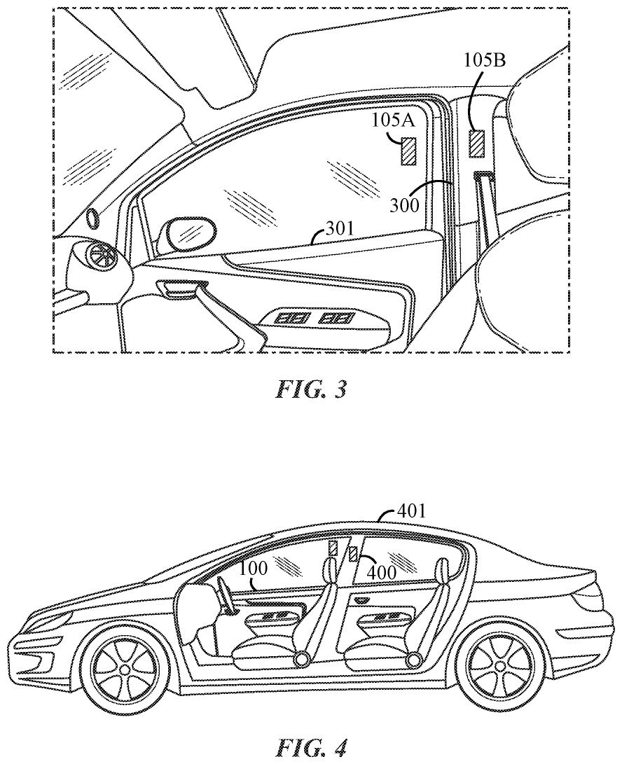

FIG. 3 illustrates a schematic of the interior of the door panel 300 and car door interior 301. The at least one sensor 105 may include a first sensor 105A and a second sensor 105B. The first sensor 105A is positioned on the door panel 300 and the second sensor 105B is positioned on the car door interior 301. The first sensor 105A and the second sensor 105B sense the opening and closing of the car door. Once the door is opened, the transmitter emits a signal to the receiver and the sound module emits an audible customizable recording. FIG. 4 illustrates a perspective view of the interior 400 of the vehicle 401. Vehicle operator(s) and/or occupant(s) receive an audible customizable recording once the door 100 is opened.

The phrase “application” as is used herein means software other than the operating system, such as software applications, software programs, database managers, internet browsers, and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

It will be appreciated by persons skilled in the art that the present embodiment is not limited to what has been particularly shown and described hereinabove. A variety of modifications and variations are possible in light of the above teachings without departing from the following claims.

What is claimed is:

1. A vehicle safety device, comprising:
at least one sensor attached to a door of a vehicle; and
a sound module in communication with the at least one sensor, the at least one sound module to emit an audible customizable recording, wherein the audible customizable recording is emitted once the door is opened.

2. The vehicle safety device of claim 1, wherein the at least one sensor is a force-resistive touch sensor or pressure sensor.

3. The vehicle safety device of claim 2, wherein the at least one sensor includes an adhesive to attach the at least one sensor to the door.

4. The vehicle safety device of claim 2, wherein the at least one sensor is attached to a door handle.

5. The vehicle safety device of claim 1, further comprising first power source in electrical communication with the at least one sensor.

6. The vehicle safety device of claim 1, further comprising a second power source in electrical communication with the sound module.

7. The vehicle safety device of claim 1, wherein the first power source and the second power source is a Li Poly battery.

8. The vehicle safety device of claim 1, further comprising a transmitter in communication with the at least one sensor, the transmitter to emit an output signal once the door is opened.

9. The vehicle safety device of claim 8, further comprising a receiver in communication with the sound module, the receiver to receive the output signal from the transmitter.

10. A vehicle safety device, comprising:
at least one sensor attached to a door latch of a vehicle;
a sound module in communication with the at least one sensor, the at least one sound module to emit an audible customizable recording, wherein the audible customizable recording is emitted once the door is opened; and
a smart device in communication with the sound module, the smart device to permit a user to record the audible customizable recording.

11. The vehicle safety device of claim 10, wherein the at least one sensor is a force-resistive touch sensor or pressure sensor.

12. The vehicle safety device of claim 11, wherein the at least one sensor includes an adhesive to attach the at least one sensor to the door.

13. The vehicle safety device of claim 12, wherein the at least one sensor is attached to a door handle.

14. The vehicle safety device of claim 13, further comprising first power source in electrical communication with the at least one sensor.

15. The vehicle safety device of claim 14, further comprising a second power source in electrical communication with the sound module.

16. The vehicle safety device of claim 15, wherein the first power source and the second power source is a Li Poly battery.

17. The vehicle safety device of claim 16, further comprising a transmitter in communication with the at least one sensor, the transmitter to emit an output signal once the door is opened.

18. The vehicle safety device of claim 17, further comprising a receiver in communication with the sound module, the receiver to receive the output signal from the transmitter.
